(19) United States
(12) Patent Application Publication
(10) Pub. No.: US 2018/0065343 A1
(43) Pub. Date: Mar. 8, 2018

(54) DEEP DRAWING FILM

(71) Applicant: WIHURI PACKAGING OY, Helsinki (FI)

(72) Inventors: Timo OUNINKORPI, Lathi (FI); Mikko KETTUNEN,, Nastola (FI)

(21) Appl. No.: 15/559,624

(22) PCT Filed: Mar. 18, 2016
(86) PCT No.: PCT/EP2016/000485

§ 371 Date: Sep. 19, 2017

(30) Foreign Application Priority Data
Mar. 20, 2015 (DE) 10 2015 003 516.9

(51) Int. Cl. B32B 27/08; B32B 27/34; B32B 27/32; B32B 27/30; B32B 27/36; B65B 55/12; B65B 47/02; B65D 65/38; A23L 3/10

(52) U.S. Cl. CPC B32B 27/08; A23V 2002/00; B32B 27/32; B32B 27/306; B32B 27/36; B65B 55/12; B65B 47/02; B65D 65/38; A23L 3/10; B32B 2307/7244; B32B 2439/70; B32B 2307/412; B32B 2307/31; B32B 2307/558; B32B 27/34

(57) ABSTRACT

The invention relates to a deep drawing film, comprising—a sealing layer,—a gas barrier layer and—an outer layer made of a polyester, wherein the outer layer has a thickness which correponds at the maximum to 40% of a total thickness of the deep drawing film. The invention is characterized in that an intermediate layer of an olefin homopolymer and/or copolymers is arranged between the gas barrier layer and the outer layer.

The invention relates to a deep-draw thermoforming film which has a sealable layer, a gas-barrier layer and an external layer made of a polyester, where the thickness of the external layer is at most 40% of the total thickness of the deep-draw thermoforming film. A film of this type is known by way of example from JP 3 051 614 B2.

Deep-draw thermoforming films are currently used in a wide variety of applications. The deep-draw thermoforming process heats the film and then molds it in a desired manner. A container is thus produced, preference being given to a tray which can be used for the packaging of, for example, food, animal feed, sanitary items, medical products or the like. Once the container or the tray has been filled, it can be sealed. This can be achieved by way of example by using a lid film. Pressure and heat are preferably used to seal this to the deep-draw thermoforming film of which the tray of a container consists. Sealing is achieved here by way of the sealable layers of the lid film and of the deep-draw thermoforming film.

A great variety of processes are used to improve the shelf life of foods. In one example here, foods are heat-treated. This type of treatment often takes places in the packaging, for example in a sealed thermoformed film. Examples of known heat-treatment processes here are pasteurization and sterilization.

In order to permit maximization of the shelf life of packaged foods, it is necessary to prevent, as far as possible, permeation of oxygen through the film into the packaging and escape from the packaging, through the film, of any protective gas that may be present in the packaging. The gas-barrier layer is used for this purpose.

It is advantageous to maximize the transparency of the deep-draw thermoforming film, and therefore its clarity, so that consumers and customers have the clearest possible view of the packaged product, for example the packaged foods. Deep-draw thermoforming films that have proved very successful in this respect have an external layer made of polyester.

JP 3051614 B2 describes a film with an external polyester layer. However, this has the disadvantage of a tendency toward curl. This can lead to problems during production of the film, and also during fabrication and processing of the film in the packaging machine. By way of example, the corners of the resultant packaging can exhibit curl. This can lead to problems in relation to the integrity of the seals, and also impairs appearance, and is regarded by customers as undesirable or unacceptable.

JP 2005/028863 proposes, for prevention of the above, increasing the thickness of the polyester layer. That document proposes layer thicknesses of from 40% to 60% of the total thickness of the deep-draw thermoforming film. Since, however, a certain minimum thickness of the remaining layers, in particular of the sealable layer and the gas-barrier layer, is essential for correct function, a thick external polyester layer leads to increased total thickness of the film. After thermoforming of the deep-draw thermoforming film, polyester layers of the thickness described give containers and trays that are almost self-supported. However, these containers are adversely affected by temperature changes. At low temperatures they tend to fracture, because they have low impact resistance, and at higher temperatures they can soften.

Deep-draw thermoforming films known as alternatives to the above have an external sublayer consisting of a polyamide. These films are significantly more flexible and less adversely affected by temperature changes. It is known that thermoforming performance and puncture resistance can be improved by using a plurality of polyamide sublayers bonded via an adhesion promoter. EP 1 098 765 describes a layer structure of this type. However, it can lead to delamination under certain conditions. In the document mentioned, polyolefin layers are therefore inserted between the polyamide layers in order to avoid said delamination. However, all of the deep-draw thermoforming films with external layer consisting of a polyamide have the disadvantage of impaired transparency. Another possible consequence of an external polyamide layer is that when the thermoformed container is cooled the film shrinks, and it is therefore impossible to comply with the desired thermoformed dimensions Another disadvantage of the use of an external PA layer is that PA is water- and moisture-absorbent, again with resultant curling of the film. This is particularly disadvantageous in the use as food packaging, for example for sausage or cheese, because these foods are often packaged in a cool and moist environment.

It is therefore an object of the invention to achieve further development of a deep-draw thermoforming film of the preamble of claim 1 in a manner that prevents the curl to which the polyester layer, and consequently the entire deep-draw thermoforming film, is subject and which renders further processing difficult, or indeed impossible. The film is moreover intended to have high transparency and high gloss, and good impact resistance.

The invention achieves the object via a deep-draw thermoforming film which has a sealable layer, a gas-barrier layer and an external layer made of a polyester, where the thickness of the external layer is at most 40% of the total thickness of the deep-draw thermoforming film, where the deep-draw thermoforming film features an intervening layer made of an olefin homo- and/or copolymer arranged between the gas-barrier layer and the external layer. Surprisingly, this additional polyolefin layer prevents curl of the thin polyester layer, without any significant impairment of the transparency and gloss of the deep-draw thermoforming film, or of the thermoformability of the deep-draw thermoforming film. The thickness of the external layer is preferably at most 30%, particularly preferably at most 20% of the total thickness of the deep-draw thermoforming film.

It is preferable to select, for the external layer, at least one thermoplastic polymer selected from the group of the homo- and copolyesters.

These homo- and copolyesters are preferably selected from a group comprising amorphous thermoplastic aliphatic, semiaromatic and aromatic homo- and copolyesters. These homo- and copolyesters derive from polyols, preferably from diols, for example ethylene glycol, 2-methyl-1,3-propanediol or 1,4-butanediol, and dicarboxylic acids or dicarboxylic acid derivatives, for example adipic acid, isophthalic acid and/or terephthalic acid. Homopolyesters is the term used for those polyesters that derive from one polyol component and one dicarboxylic acid component. Suitable homopolyesters are preferably selected from the group comprising PET and PBT. PET means polyethylene terephthalate, which can be produced from ethylene glycol and terephthalic acid. PBT means polybutylene terephthalate, which can be produced from butane-1,4-diol and terephthalic acid. The preferably amorphous scope is indicated here by the prefix “A”. A particularly preferred amorphous homopolyester is APET (amorphous PET).

Copolyesters is the term used for those polyesters which comprise not only one polyol component and one dicarboxylic acid component but also at least one further comonomer. Suitable preferably amorphous copolyesters are copolyesters made of an aromatic dicarboxylic acid, for example terephthalic acid, an aliphatic glycol, for example ethylene glycol, and at least one further monomer, preferably at least one further monomer selected from the group comprising preferably branched aliphatic polyols, aromatic polyols and cycloaliphatic polyols, or aliphatic and aromatic dicarboxylic acids. A particularly preferred amorphous copolyester derives from ethylene glycol, terephthalic acid and 1,4-cyclohexanedimethanol. Another preferred copolyester derives from ethylene glycol, terephthalic acid and isophthalic acid.

The external layer of the deep-draw thermoforming film is advantageously based on at least one amorphous homopolyester made of an aromatic dicarboxylic acid and of an aliphatic polyol, or on at least one amorphous copolyester made of at least one aromatic dicarboxylic acid and of at least one aliphatic and at least one cycloaliphatic polyol, or on at least one amorphous copolyester made of at least two aromatic dicarboxylic acids and of at least one aliphatic polyol.

It is particularly preferable that the external layer of the deep-draw thermoforming film is based on at least one amorphous homopolyester made of an aromatic dicarboxylic acid and of an aliphatic diol, or of at least one amorphous copolyester made of at least one aromatic dicarboxylic acid and of at least one aliphatic and at least one cycloaliphatic diol, or on at least one amorphous copolyester made of at least two aromatic dicarboxylic acids and of at least one aliphatic diol.

It is preferable that the gas-barrier layer consists at least to some extent of a polyamide (PA). The gas-carrier layer here can also consist entirely of PA.

Suitable polyamides are homo- and/or copolyamides which are preferably selected from the group comprising thermoplastic aliphatic, semiaromatic and aromatic homo- and copolyamides. These homo- and copolyamides can be composed of aliphatic and/or cycloaliphatic diamines having from 2 to 10 carbon atoms, for example hexamethylenediamine and/or of aromatic diamines having from 6 to 10 carbon atoms, for example p-phenylenediamine, and of aliphatic and/or aromatic dicarboxylic acids having from 6 to 14 carbon atoms, for example adipic acid, terephthalic acid or isoterephthalic acid. These homo- and copolyamides can moreover be produced from lactams having from 4 to 10 carbon atoms, for example from ε-caprolactam. The homo- and/or copolyamides are advantageously selected from the group comprising PA 6, PA 12, PA 66, PA 6I, PA 6T corresponding copolymers and mixtures of at least two of the polymers mentioned.

In a preferred embodiment, the gas-barrier layer has a plurality of sublayers. The gas-barrier layer particularly preferably has at least three sublayers with two external sublayers made of a polyamide (PA) and with a middle sublayer made of another material in order to improve the gas barrier, preferably ethylene-vinyl alcohol copolymer (EVOH). It is preferable that the middle sublayer is based on at least one thermoplastic polymer selected from the group comprising ethylene-vinyl alcohol copolymers (EVOH), at least partially hydrolyzed polyvinyl acetates, polyvinylidene chloride (PVDC), vinylidene chloride copolymers, preferably with at least 80% vinylidene chloride content, based on the total weight of the vinylidene chloride copolymer, or on a mixture of at least two of the polymers mentioned, particularly preferably involving at least one ethylene-vinyl alcohol copolymer.

The ethylene-vinyl alcohol copolymers (EVOH) used for the production of the middle sublayer are obtained via complete or incomplete hydrolysis of corresponding ethylene-vinyl acetate copolymers (EVAc). It is preferable to use fully hydrolyzed ethylene-vinyl acetate copolymers with a degree of hydrolysis of more than 98% and with from 0.01 to 80 mol % ethylene content, preferably from 1 to 50 mol %, based in each case on the total weight of the ethylene-vinyl alcohol copolymer.

The partially hydrolyzed polyvinyl acetates used for the production of the middle sublayer are obtained via complete or incomplete hydrolysis of corresponding polyvinyl acetates. At least partially hydrolyzed polyvinyl acetates used for the production of the middle sublayer are particularly preferably selected from the group comprising fully hydrolyzed polyvinyl acetates (polyvinyl alcohols, PVOH) with a degree of hydrolysis of more than 98% and partially hydrolyzed polyvinyl acetates with a degree of hydrolysis of from 75% to, and inclusive of, 98%.

As alternative to the above, the gas-barrier layer consists at least to some extent of a polyester. It has been found to be particularly advantageous for the gas-barrier layer to consist entirely of polyester. This firstly provides an adequate gas barrier and secondly further increases the transparency and gloss of the deep-draw thermoforming film. The materials from which the polyester is selected can be the same as those from which the polyester of the external layer is selected.

In a particularly advantageous embodiment, the gas-barrier layer has at least three sublayers, with two external sublayers made of a polyester and with a middle sublayer made of ethylene-vinyl alcohol copolymer (EVOH). It is preferable that adhesion promoters are used to bond the external sublayers and the middle sublayer to one another. The prior art discloses a wide variety of adhesion promoters that can be used. In a preferred embodiment, however, the external sublayers and the middle sublayer have been bonded to one another by means of a modified polyesterether admixed in a proportion of up to 50% with at least one of the sublayers intended for bonding to one another, preference being given to a polyesterether modified by maleic anhydride groups. The modified polyesterether is admixed with one or both of the sublayers respectively intended for bonding, and thus leads to adhesion between the individual sublayers.

The sealable layer preferably consists of a heat-sealable thermoplastic polymer selected from the group comprising olefin homo- and copolymers and copolymers of at least one olefin and of at least one other α,β-unsaturated, non-olefinic monomer, and optionally has a plurality of sublayers. Olefin homo- and copolymers suitable for the production of the sealable layer are preferably thermoplastic olefin homo- or copolymers of α,β-unsaturated olefins having 2, 3, 4, 5, 6, 7, 8, 9 or 10 carbon atoms. Suitable olefin homopolymers are preferably selected from the group comprising ethylene homopolymers (polyethylenes, PE), preferably LDPE and HDPE, propylene homopolymers (polypropylenes, PP), butylene homopolymers (polybutylenes, PB) and isobutylene homopolymers (poly-isobutylenes, PI) and mixtures of at least two of the polymers mentioned. LDPE is the term used for low-density polyethylenes with density in the range from 0.86 to 0.93 g/cm³ featuring a high degree of branching of the molecules. HDPE is the term used for high-density polyethylenes which have only a low degree of molecular-chain branching, with density that can be in the range from 0.94 to 0.97 g/cm³. Suitable olefin copolymers are preferably copolymers of ethylene and/or propylene and of at least one α-olefin having at least 4 carbon atoms, preferably from 4 to 10, particularly preferably from 4 to 8, very particular preference being given to copolymers of ethylene and/or propylene with at least one α-olefin selected from the group comprising butene, hexene and octene. The α-olefin content in the olefin copolymer is preferably at most 25% by weight, particularly preferably at most 15% by weight, based on the total weight of the olefin copolymer. Particularly suitable copolymers of ethylene and of at least one α-olefin having at least 4 carbon atoms are LLDPE and mPE. LLDPE is the term used for linear low-density ethylene copolymers which are characterized by the presence of a linear main chain with pendant chains located thereon, their density being in the range from 0.86 to 0.94 g/cm³. mPE is the term used for ethylene copolymers which are polymerized by means of metallocene catalysts, their density preferably being in the range from 0.88 to 0.93 g/cm³.

Mixtures of olefin copolymers and/or of olefin homo-polymers can also be used for the production of the sealable layer, but transparency of the layer must be ensured. In particular, the content of the olefin copolymer here in the mixture is preferably higher than the content of the olefin homopolymer. Particular preference is given to a mixture of mPE, LLDPE and/or LDPE. It is very particularly preferable that the sealable layer is based on an mPE, on an LLDPE, on a mixture of from 40% to 90% by weight of mPE and 60 to 10% by weight of LLDPE, on a mixture of from 60 to 10% by weight of mPE and from 40 to 90% by weight of LLDPE, on a mixture of from 20 to 50% by weight of LLDPE and from 80 to 50% by weight of LDPE, on a mixture of from 20 to 50% by weight of LDPE and from 80 to 50% by weight of LLDPE, on a mixture of from 20 to 50% by weight of LDPE and from 80 to 50% by weight of mPE, or on a mixture of from 20 to 50% by weight of mPE and from 80 to 50% by weight of LDPE, based in each case on the total weight of the sealable layer, where the total of the percentage by weight contents must always be 100% by weight.

It is preferable that the olefin content in the olefin copolymer of the transparent sealable layer is at least 75%, preferably at least 80%, particularly preferably at least 85%, based in each case on the total weight of the olefin copolymer.

Copolymers of at least one olefin and of at least one other α,β-unsaturated, non-olefinic monomer that are suitable for the production of the transparent sealable layer are preferably copolymers of at least one olefin selected from the group comprising ethylene, propylene, butylene and isobutylene, preferably ethylene and/or propylene, and of at least one other α,β-unsaturated, non-olefinic monomer having at least one oxygen-containing group, preferably at least one ester group and/or one acid group. Particularly suitable copolymers are those of at least one olefin, for example ethylene, and of at least one compound selected from the group comprising vinyl acetate, alkyl(meth)acrylates, preferably C₁₋₄-alkyl (meth)acrylates, particularly preferably methyl(meth)acrylate, ethyl (meth)acrylate, n- and isopropyl (meth)acrylate, n- and isobutyl (meth)acrylate, tert-butyl (meth) acrylate, 2-ethylhexyl (meth)acrylate, cyclohexyl (meth)acrylate and isobornyl (meth)acrylate, and (meth)acrylate acid. Particular preference is given as comonomer to at least one α,β-unsaturated, non-olefinic monomer selected from the group comprising vinyl acetate, (meth)acrylate and (meth)acrylic acid.

For the purposes of the present invention, the terms (meth)acrylate and (meth)acrylic acid encompass alkyl methacrylates and methacrylic acid and also alkyl acrylates and acrylic acid.

It is preferable that the olefin content in the copolymer of at least one olefin and of at least one other α,β-unsaturated, non-olefinic monomer of the sealable layer is at least 60%, preferably at least 65%, particularly preferably at least 70%, very particularly preferably at least 75%, based in each case on the total weight of the copolymer.

It is preferable that the sealable layer is based on at least one thermoplastic polymer selected from the group comprising olefin homo- and copolymers and copolymers of at least one olefin and of at least one other α,β-unsaturated, non-olefinic monomer.

It is particularly preferable that the sealable layer is based on at least one copolymer of ethylene and/or propylene, preferably ethylene, and of at least one α-olefin having at least 4 carbon atoms, preferably butene, hexene and/or octene, or on at least one ethylene copolymer selected from the group comprising ethylene-vinyl acetate copolymers, ethylene-C₁-₄-alkyl (meth)acrylate copolymers and ethylene-(meth)acrylic acid copolymers, preferably on at least one ethylene-vinyl acetate copolymer or on at least one ethylene-C₁₋₄-alkyl (meth)acrylate copolymer.

The thickness of the sealable layer is advantageously at least 5 μm, with particular preference more than 8 μm, with particular preference from 8 to 100 μm.

For specific applications, the sealable layer can also take the form of what is known as peel layer. An example of a known process for achieving the peel effect is the addition of polybutylene in polyethylene or ethylenic copolymers. These processes are known to the person skilled in the art.

Antifogging properties have advantageously been provided to the sealable layer. It is preferable here that the sealable layer comprises at least one antifogging additive or that at least one side of the sealable layer has a coating based on at least one antifogging additive. Antifogging additives are known to the person skilled in the art; it is preferable to use at least one additive selected from the group comprising alkoxylated amines, alkoxylated amides and polyol-fatty-acid esters, preferably glycerol-fatty-acid esters or sorbitan monoesters, or else selected from appropriate salts of these. If at least one side of the sealable layer is coated with at least one antifogging additive, the sealable layer can optionally be corona-(pre)treated prior to this coating.

Antiblocking additives and slip additives known to a person skilled in the art can be used in the sealable layer in order to improve ease of running in machinery.

The intervening layer advantageously consists likewise of a thermoplastic polymer selected from the group comprising olefin homo- and copolymers and copolymers of at least one olefin and of at least one other α,β-unsaturated, non-olefinic monomer. The relevant materials here are the same as those for the sealable layer. It is particularly preferable that the intervening layer is based on at least one copolymer of ethylene and propylene or on a homopolypropylene.

It is preferable that individual layers have been bonded to one another via an adhesion promoter. This avoids use of adhesives that can lead to evolution of gases and also, under certain circumstances, to delamination.

Materials suitable for the production of the adhesion-promoter layers are thermoplastic polymers modified by polar groups, preferably by organic acid groups and/or organic anhydride groups, particularly preferably by cyclic organic anhydride groups, very particularly preferably by maleic anhydride groups. The person skilled in the art is aware of methods for the modification of the thermoplastic polymers that are suitable for the production of the adhesion-promoter layers. It is preferable that the modification has been achieved via grafting on the thermoplastic polymers.

The adhesion-promoter layers are preferably based on at least one modified thermoplastic olefin homo- and/or copolymer. The type of thermoplastic olefin homo- or copolymer used here can be the same as the type that can also be used for the production of the sealable layer or the intervening layer. It is particularly preferable that the adhesion-promoter layers are based on at least one ethylene or propylene homo- or copolymer modified by cyclic inorganic anhydride groups, particularly preferably on an ethylene or propylene homo- or copolymer modified by maleic anhydride groups.

The layer thickness of the adhesion-promoter layers is preferably at most 10 μm, particularly preferably at most 5 μm, very particularly preferably at most 3 μm.

The total thickness of the deep-draw thermoforming film is preferably from 30 μm to 300 μm, the thickness of the external layer being from 2 μm to 120 μm.

The deep-draw thermoforming film can itself be produced by any of the commonly used production processes; it is preferably produced by way of an extrusion or coextrusion process. It is possible here to use either blown-film extrusion or flat-film extrusion.

It is preferable that, in an embodiment of the present invention, the deep-draw thermoforming film is used as food packaging, where at least a portion of the packaging has been produced via a thermoforming process from the deep-draw thermoforming film. In a particularly preferred embodiment of this use, the food is pasteurized in the packaging.

The following methods were used to determine parameters for films described here: transparency of the films is determined by way of their haze (in accordance with ASTM D1003-61), gloss (in accordance with DIN EN ISO 2813 and DIN 67 530) and clarity (in accordance with ASTM D1746). Haze here means the amount of light emitted from a test sample of the film at a solid angle of from more than 8° to at most 160° when a central beam of light passes through the sample. Haze is stated in percent, based on the total amount of transmitted light. The total amount of light therefore corresponds to 100 percent.

Gloss of the film is the proportion of standard reflected light, based on a light beam incident at an angle of 20° from vertical. Gloss is stated in gloss units (GE), based on a black glass standard with refractive index 1.567.

Clarity means the clarity of an object viewed through a film. The solid angle within which the light is deflected is small, and the scattered light is therefore concentrated within a thin wedge. Clarity is mirrored in the angular range <2.5°.

Comparative experiments are carried out here in relation to transparency and gloss. A film of an embodiment of the present invention was compared here with a standard film. The film structure is shown in the blocks below:

Standard Structure:

| PE | AP | PA | EVOH | PA | AP | PP | AP | PA |
|---|---|---|---|---|---|---|---|---|
| 37.0 | 4.0 | 13.0 | 6.0 | 13.0 | 4.0 | 25.0 | 5.0 | 13.0 |

The numerical values give the thickness of each layer in micrometers.

Comparative film of an embodiment of the present invention:

| PE | AP | PA | EVOH | PA | AP | PP | AP | PA |
|---|---|---|---|---|---|---|---|---|
| 37.0 | 4.0 | 13.0 | 6.0 | 13.0 | 4.0 | 25.0 | 5.0 | 13.0 |

“AP” in both structures means an adhesion promoter.

The results for the film of the invention were haze 5.8%, gloss 117 and clarity 95.3%. In contrast, these values for the standard film were 6.9% haze, gloss 111 and clarity 93.6%. the film of the embodiment of the present invention is therefore significantly better in all three of these respects.

Adhesion properties were moreover determined. In particular, adhesion of the film on the metallic thermoforming mold after thermoforming must be minimized in order to ensure good processing. Adhesion properties on aluminum were therefore determined in the present tests. The layer structure of an embodiment of the present invention, already described above, was used. A layer structure made of a 200 μm layer of APET (amorphous polyester) and of a 50 μm layer of polyethylene is used as standard comparative film.

Adhesion prior to and after a thermoforming procedure was measured. The property known as seal strength was determined here in accordance with DIN 55529. Adhesion is measured by sealing the film on aluminum, prior to and after thermoforming.

The seal strength was then determined, where this means the maximal force in newtons required to separate a seal that has been produced under defined conditions. these defined conditions comprise pressure, time and temperature.

The thermoforming of each of the films was carried out at a mold temperature of 100° C. in a standard packaging machine. Draw depth was 40 mm for a sheet measuring 180×113 mm. A sealing device (smooth sealing jaws) was then used to seal the external side of film to an aluminum foil at 150° C. for 0.5 second under a pressure of 50 newtons/cm². A strip of width 15 mm was cut out for testing. The longer, unsealed ends of the two film strips are fastened in a tensile tester in such a way that the angle between the strips to be separated from one another was about 180°. The force required to separate the two films is determined over a test distance representing the region of the seal. The test equipment used is a computer-controlled tensile tester. The force measured in newtons corresponds to the force required to separate the two test strips from one another along the seal of width 15 mm. The force determined for separation of the 15 mm seal in the case of a known reference film structure, prior to and after thermoforming, was 0.4 N. In the case of the film of an embodiment of the present invention, the forces required were again 0.4 N prior to film forming, but only 0.3 N after thermoforming. This means less adhesion after thermoforming, and it is thus possible to improve the processability of the films by using lower polyester thicknesses.

The shrinkage properties of the film were moreover determined directly after thermoforming. For this, packaging was thermoformed at 90° C. in a standard thermoforming system. Draw depth was 60 mm for a sheet measuring 114×223 mm. The lengths and widths of the thermoformed samples were measured directly after thermoforming, and compared with the sheet dimensions. Tests were carried out on the abovementioned standard film and on the embodiment described in the present invention. Whereas the shrinkage of the standard film was from 3.3% to 4.9%, the shrinkage observed for the film of the embodiment of the present invention was from 0.4% to 1.8%. Shrinkage properties are therefore markedly improved by the present invention.

1. A deep-draw thermoforming film, comprising:
a sealable layer;
a gas-barrier layer;
an external layer made of a polyester,
where the thickness of the external layer is at most 40% of the total thickness of the deep-draw thermoforming film; and
an intervening layer made of an olefin homo- and/or copolymer arranged between the gas-barrier layer and the external layer.

2. The deep-draw thermoforming film as claimed in claim 1, wherein the external layer consists of a homopolyester and/or of a copolyester.

3. The deep-draw thermoforming film as claimed in claim 1, wherein the gas-barrier layer includes a polyamide.

4. The deep-draw thermoforming film as claimed in claim 1, wherein the gas-barrier layer has at least three sublayers including at least two external sublayers each of which are made of a polyamide, and at least one middle sublayer made of ethylene-vinyl alcohol copolymer.

5. The deep-draw thermoforming film as claimed in claim 1, wherein the gas-barrier layer includes a polyester.

6. The deep-draw thermoforming film as claimed in claim 1, wherein the gas-barrier layer has at least three sublayers including at least two external sublayers each of which are made of a polyester and at least one middle sublayer made of ethylene-vinyl alcohol copolymer.

7. The deep-draw thermoforming film as claimed in claim 6, wherein each of the at least two external sub-layers and the at least one middle sublayer are bonded to one another by a modified polyesterether admixed in a proportion of up to 50% with at least one of the at least three sublayers.

8. The deep-draw thermoforming film as claimed in claim 1 wherein the sealable layer includes an olefin homo- and/or copolymer.

9. The deep-draw thermoforming film as claimed in claim 1 further comprising an adhesion promoter for bonding together two or more layers selected from the sealable layer, the gas-barrier layer, the external layer, and the intervening layer.

10. The deep-draw thermoforming film as claimed in claim 1 wherein the intervening layer includes a polypropylene homo- and/or copolymer.

11. A method for packaging food, comprising placing food in food packaging where at least a portion of the food packaging is or includes a deep-draw thermoforming film comprising a sealable layer, a gas-barrier layer, an external layer made of a polyester where the thickness of the external layer is at most 40% of the total thickness of the deep-draw thermoforming film, and
an intervening layer made of an olefin homo- and/or copolymer arranged between the gas-barrier layer and the external layer.

12. The method of claim 11, further comprising pasteurizing the food after the food is in the food packaging.

13. The deep-draw thermoforming film as claimed in claim 7 wherein the polyesterether is modified by maleic anhydride groups.

14. The deep-draw thermoforming film as claimed in claim 8 wherein the olefin homo- and/or copolymer is a polyethylene homo- and/or copolymer.
